(19) United States
(12) Patent Application Publication
(10) Pub. No.: US 2023/0309747 A1
(43) Pub. Date: Oct. 5, 2023

(54) GRILL APPARATUS

(71) Applicant: Hyeok Choi, Seoul (KR)

(72) Inventor: Hyeok Choi, Seoul (KR)

(21) Appl. No.: 18/201,149

(22) Filed: May 23, 2023

(30) Foreign Application Priority Data
Apr. 4, 2022 (KR) 10-2022-0041639

(51) Int. Cl. A47J 37/07; F24C 15/14

(52) U.S. Cl. CPC A47J 37/0786; F24C 15/14

(57) ABSTRACT

Disclosed is a grill apparatus including a grill receiving part, an upper side of which is opened, a grill part accommodated in an interior of the grill receiving part and in which a food is grilled, and a water passage pipe provided in a widthwise direction of the grill receiving part on one side of the grill receiving part, provided on an upper side of the grill part, and which discharges water that flows in an interior thereof toward the grill part. The water discharged from the water passage pipe flows down along the grill part to remove foreign substances that are present on a surface of the grill part.

### CROSS-REFERENCE TO RELATED APPLICATIONS

A claim for priority under 35 U.S.C. § 119 is made to Korean Patent Application No. 10-2022-0041639 filed on Apr. 4, 2022, in the Korean Intellectual Property Office, the entire contents of which are hereby incorporated by reference.

### BACKGROUND

Embodiment of the inventive concept described herein relates to a grill apparatus, from which foreign substances may be removed.

Due to development of boarding-out, meat has been increasingly consumed, and the meat is consumed in various ways, but it is general to grill the meat by applying heat. Due to the trends, grills are widely used to grill meat in restaurants that sell meat, camping grounds, country houses, or the like.

However, according to a conventional grill, foreign substances (residues) generated in a process of grilling meat drop, and thus, tastes or flavors of the meat are lost and the grills are stained, which is insanitary.

### SUMMARY

An aspect of the inventive concept provides a grill apparatus that may remove foreign substances stuck to a surface of a grill.

The technical problems to be solved by the inventive concept are not limited to the aforementioned problems, and any other technical problems not mentioned herein will be clearly understood from the following description by those skilled in the art to which the inventive concept pertains.

According to an aspect of the inventive concept, a grill apparatus includes a grill receiving part, an upper side of which is opened, a grill part accommodated in an interior of the grill receiving part and in which a food is grilled, and a water passage pipe provided in a widthwise direction of the grill receiving part on one side of the grill receiving part, provided on an upper side of the grill part, and which discharge water that flows in an interior thereof toward the grill part, and the water discharged from the water passage pipe flows down along the grill part to remove foreign substances that are present on a surface of the grill part.

The grill receiving part may include a mounting recess provided on upper ends of opposite side plates on one side of the grill receiving part, and the water passage pipe may be inserted into and mounted in the mounting recess.

The water passage pipe may include a plurality of water discharge holes provided at a lower end of the water passage pipe to be spaced apart from each other along a lengthwise direction of the water passage pipe, and the water supplied from an outside may flow along an interior of the water passage pipe and may be discharged to a lower side through the water discharge holes.

The water passage pipe may further include a plurality of screw-coupling holes provided at a lower end of the water passage pipe, spaced apart from each other along the lengthwise direction of the water passage pipe, to which screws are coupled respectively.

The screw-coupling holes may be provided at locations corresponding to the water discharge holes.

The grill part may be provided to be inclined downwards from one side to an opposite side of the grill receiving part and may be configured such that the water discharged through the water discharge holes flows down to the opposite side of the grill receiving part along a surface of the grill part.

The grill apparatus may further include a discharge hole provided on an opposite side of the grill receiving part and through which the water that flows down along the surface of the grill part is discharged.

The grill part may include a plurality of first grill parts arranged in parallel along the widthwise direction of the grill receiving part, and a plurality of second grill parts provided on a lower side of the first grill parts, and arranged along the widthwise direction of the grill receiving part.

Each of the first grill parts may include a concave inclined part, opposite sides of which are inclined downwards toward a center thereof, and an extension part extending upwards from one end of the concave inclined part.

The extension part may include a first extension part extending from one end of the concave inclined-part at the same inclination angle as that of the concave inclined-part, and a second extension part extending from an end of the first extension part at an inclination angle that is different from that of the first extension part.

The second grill part may be provided in a form corresponding to the concave inclined-part, and may be provided at a location corresponding to the concave inclined-part.

The grill apparatus may further include a red clay layer formed on a surface of the second grill part.

The grill apparatus may further include a grill support part, in which the grill receiving part is seated at an upper end thereof, and a heat transfer part provided on a lower side of the grill receiving part on an inside of the grill support part and which transfer heat generated by a heat source to the grill receiving part.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a perspective view illustrating a grill apparatus according to an embodiment of the inventive concept;

FIG. 2 is a view illustrating a state, in which a cover part is opened in a grill apparatus according to an embodiment of the inventive concept;

FIG. 3 is a view illustrating a state, in which a heat source receiving part is installed in a grill apparatus according to an embodiment of the inventive concept;

FIG. 4 is a view illustrating a state, in which a charcoal ignitor is used in a grill apparatus according to an embodiment of the inventive concept;

FIG. 5 is a perspective view illustrating a grill receiving part and a grill part in a grill apparatus according to an embodiment of the inventive concept; and

FIG. 6 is a view illustrating a water passage pipe according to an embodiment of the inventive concept.

### DETAILED DESCRIPTION

Hereinafter, embodiments of the inventive concept will be described in detail with reference to the accompanying drawings. The embodiments of the inventive concept may be modified into various forms, and a scope of the inventive concept should not be construed as being limited to the following embodiments. The present embodiments are provided to describe the inventive concept to an ordinary person in the art more fully. Accordingly, shapes of components in the drawings are exaggerated to emphasize a clearer description.

Configurations of the inventive concept for making a measure for solving a problem to be solved by the inventive concept clear will be described in detail with reference to the accompanying drawings based on preferred embodiments of the inventive concept, and it will be noted in advance that the same components are endowed with the same reference numerals even though they are in different drawings when the components in the drawings are endowed with reference numerals and the components in another drawing may be cited if necessary when the corresponding drawing is described.

Meanwhile, directional terms, such as an upper side, a lower side, one side, and an opposite side, are used in relation to orientations of the disclosed drawings. The components of the embodiment of the inventive concept may be set in various orientations, and the directional terms are used for the purpose of examples and the inventive concept is not limited to them.

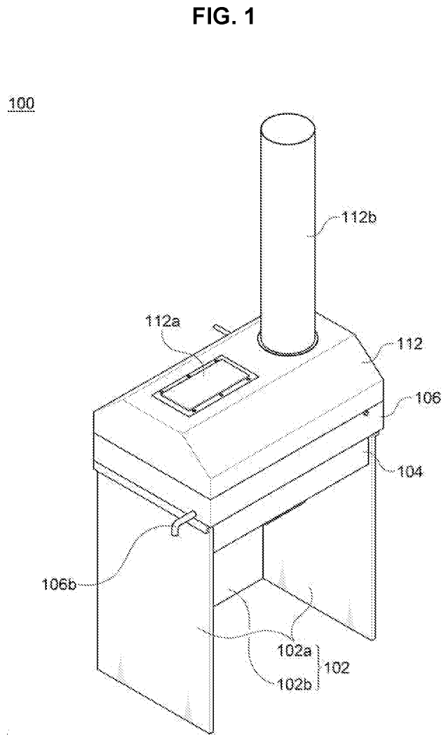

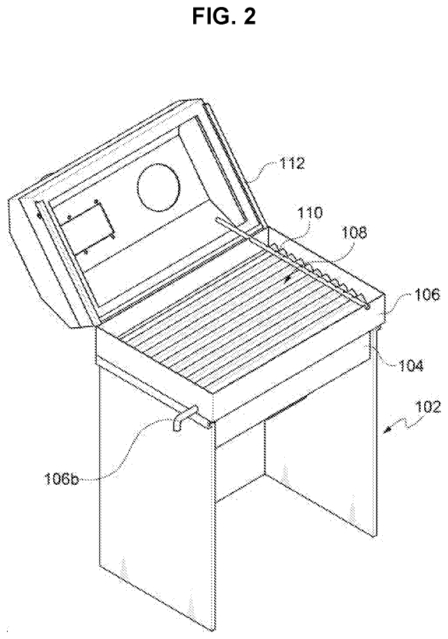

FIG. 1 is a perspective view illustrating a grill apparatus according to an embodiment of the inventive concept. FIG. 2 is a view illustrating a state, in which a cover part is opened in the grill apparatus according to an embodiment of the inventive concept.

Referring to FIGS. 1 and 2, a grill apparatus 100 may include a grill support part 102, a heat transfer part 104, a grill receiving part 106, a grill part 108, a water passage pipe 110, and a cover part 112.

The grill support part 102 may function to structurally support the grill apparatus 100. In an embodiment, the grill support part 102 may include a pair of side plates 102a and a rear plate 102b. The pair of side plates 102a may be provided perpendicularly to a ground surface and may be configured to face each other while being spaced apart from each other by a specific distance. The rear plate 102b may connect the pair of side plates 102a at rear ends of the pair of side plates 102a. Here, a front side of the grill support part 102 may be opened. Here, only an embodiment of the grill support part 102 is illustrated, and a form of the grill support part 102 is not limited thereto.

The heat transfer part 104 may be coupled to an inside of an upper end of the grill support part 102. The heat transfer part 104 may be coupled to be extracted from the upper end of the grill support part 102. For example, the heat transfer part 104 may be coupled to the pair of side plates 102a to be slid at the upper end of the grill support part 102. The heat transfer part 104 may be provided in a form of a drawer. The heat transfer part 104 may function to transfer heat generated by a heat source (not illustrated) to the grill receiving part 106 located on an upper side of the heat transfer part 104.

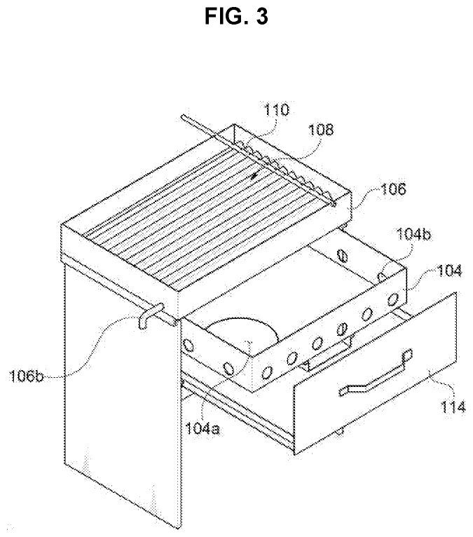

Meanwhile, as illustrated in FIG. 3, the grill apparatus 100 may further include a heat source receiving part 114. The heat source receiving part 114 may be provided on a lower side of the heat transfer part 104 in the grill support part 102. The heat source receiving part 114 may be configured to be extracted from the grill support part 102. The heat source receiving part 114 may be coupled to the pair of side plates 102a to be slid in the grill support part 102.

In an embodiment, the heat source receiving part 114 may be configured to receive charcoal. Then, the heat transfer part 104 may transfer the heat generated in the charcoal received in the heat source receiving part 114 to the grill receiving part 106. A vent hole part 104a may be provided on a bottom surface of the heat transfer part 104 such that the heat generated in the charcoal received in the heat source receiving part 114 is communicated therethrough. In this case, the heat generated in the charcoal received in the heat source receiving part 114 may be transferred immediately to the grill receiving part 106 through the vent hole part 104a.

Furthermore, a plurality of air passage holes 104b for supplying exterior air to the heat source receiving part 114 may be provided on each of side surfaces of the heat transfer part 104. Because the exterior air is supplied to the heat source receiving part 114 through the plurality of air passage holes 104b, the charcoal received in the heat source receiving part 114 may flare up better and thermal power becomes higher. The heat source receiving part 114 may be configured to be detached from the grill support part 102. In this case, when the charcoal runs out, the heat source receiving part 114 is detached from the grill support part 102 and the charcoal is discarded.

Here, although it has been described that the charcoal is received in the heat source receiving part 114, the inventive concept is not limited thereto, and a heat source, such as a gas burner, may be mounted on a lower side of the heat transfer part 104 without using the heat source receiving part 114 whereby heat may be transferred to the grill receiving part 106 through the heat transfer part 104.

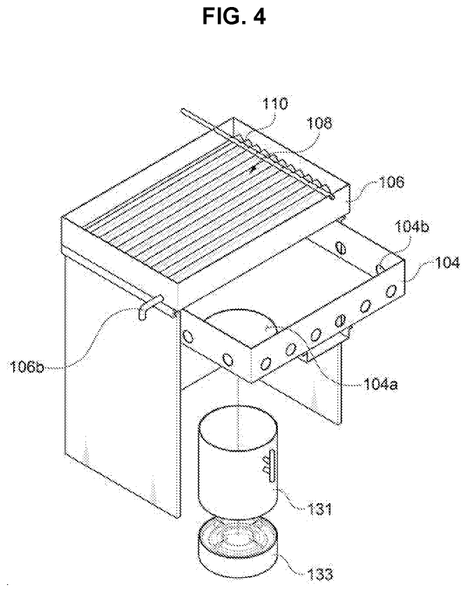

Meanwhile, as illustrated in FIG. 4, the heat may be transferred to the grill receiving part 106 through the heat transfer part 104 by using a charcoal igniter 131. In this case, after the heat source receiving part 114 is detached from the grill support part 102, the charcoal igniter 131 may be disposed on a lower side of the vent hole part 104a. The charcoal may be accommodated in an interior of the charcoal igniter 131, and a heat source, such as a burner, may be provided on a lower side of the charcoal igniter 131 to ignite the charcoal.

The grill receiving part 106 may be provided on an upper side of the grill support part 102. The grill receiving part 106 may be provided on an upper side of the heat transfer part 104 to be seated on an upper end of the grill support part 102. The grill receiving part 106 may be mounted on the upper end of the grill support part 102 to be detachable. The grill receiving part 106 may be provided such that the grill part 108 is received in an interior thereof. In an embodiment, the grill receiving part 106 may have an open-topped hexagonal shape, but the shape thereof is not limited thereto.

A mounting recess 106a, on which the water passage pipe 110 is mounted, may be provided on one side of the grill receiving part 106. The mounting recess 106a may be provided by partially cutting upper ends of the opposite side plates formed in a widthwise direction of the grill receiving part 106 on one side of the grill receiving part 106. Furthermore, a discharge hole 106b may be provided on an opposite side of the grill receiving part 106 to protrude. The discharge hole 106b may be provided to be curved from an outer surface of the grill receiving part 106 on an opposite side to a lower side.

The grill part 108 may be provided in an interior of the grill receiving part 106. The grill part 108 is a part, on which meat is laid, and is a part, on which the meat is grilled by the heat transferred through the heat transfer part 104. The grill part 108 may be provided to be inclined in the interior of the grill receiving part 106. The grill part 108 may be provided to be inclined downwards from one side (a side, on which the water passage pipe 110 is mounted) of the grill receiving part 106 to an opposite side (a side, on which the discharge hole 106b is formed). One side of the grill part 108 may be disposed on a lower side of the water passage pipe 110.

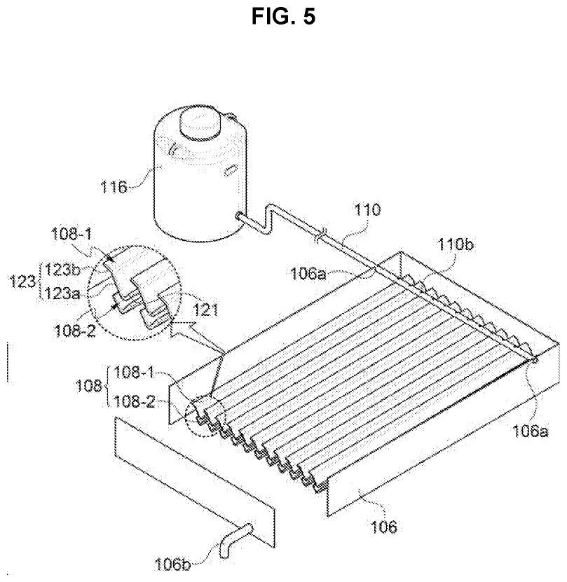

FIG. 5 is a perspective view illustrating a grill receiving part and a grill part in a grill apparatus according to an embodiment of the inventive concept. Referring to FIG. 5, the grill part 108 may include a first grill part 108-1 and a second grill part 108-2. A plurality of first grill parts 108-1 may be provided in an interior of the grill receiving part 106 to be arranged in parallel at a specific interval along a widthwise direction of the grill receiving part 106. The first grill parts 108-1 may be provided along a lengthwise direction (a direction from one side to an opposite side of the grill receiving part 106) of the grill receiving part 106.

Each of the first grill part 108-1 may include a concave inclined-part 121 and an extension part 123. The concave inclined-part 121 may be provided such that opposite sides thereof are inclined downwards toward a center thereof. That is, the concave inclined-part 121 may have a wedge shape (a “V” shape). The extension part 123 may be provided at one end of the concave inclined-part 121 to extend upwards. The extension part 123 may include a first extension part 123a that extends from one end of the concave inclined-part 121 at the same inclination as that of the concave inclined-part 121, and a second extension part 123b that extends from an end of the first extension part 123a at an inclination that is different from that of the first extension part 123a.

Because the first grill part 108-1 is formed in an interior of the grill receiving part 106 to be inclined downwards from one side to an opposite side of the first grill part 108-1 and the first grill part 108-1 has the wedge shape, the water flows down along a surface of the first grill part 108-1 when the water drops from the water passage pipe 110. In this process, foreign substances (or residues) that are present in the first grill part 108-1 are rinsed together with the water and go down. Furthermore, the water and the foreign substances that flow down along the first grill part 108-1 are discharged to an outside through the discharge hole 106b.

The second grill part 108-2 may be provided on a lower side of the first grill part 108-1 to be spaced apart from the first grill part 108-1. The second grill part 108-2 may be provided at a location of the first grill part 108-1, which corresponds to the concave inclined-part 121, but the inventive concept is not limited thereto, and may be provided between the adjacent concave inclined-parts 121. The second grill part 108-2 may have a shape (that is, a wedge shape) that is the same as or similar to that of the concave inclined-part 121.

Here, because the second grill part 108-2 is provided on the lower side of the first grill part 108-1, the foreign substances or the water may flow down along the second grill part 108-2 when they drop into an aperture between the first grill parts 108-1. The second grill part 108-2 may be provided to be separable from the first grill part 108-1. In this case, after the second grill part 108-2 is detached, the foreign substances stuck to the second grill part 108-2 may be removed or the second grill part 108-2 may be cleaned.

A red clay layer (not illustrated) may be formed on a surface of the second grill part 108-2. That is, the red clay layer may be formed by applying clay onto the surface of the second grill part 108-2. In this case, the water may be prevented from spattering when the water drops from the water passage pipe 110 to the grill part 108 even though a temperature of the grill part 108 rises.

The water passage pipe 110 may be provided on one side of the grill receiving part 106 in a widthwise direction of the grill receiving part 106. In an embodiment, the water passage pipe 110 may be mounted on the mounting recess 106a formed in the grill receiving part 106. The water passage pipe 110 have a hollow pipe shape. A cross-section of the water passage pipe 110 may be circular, but the inventive concept is not limited thereto, and it may be four-sided. The water passage pipe 110 is provided on an upper side of the grill part 108.

An end of the water passage pipe 110 may be connected to a water tank 116. The end of the water passage pipe 110 may be connected to the water tank 116 through a hose (not illustrated), but the inventive concept is not limited thereto, and the end of the water passage pipe 110 may be directly connected to the water tank 116.

A water adjusting lever (not illustrated) for adjusting discharge of the water accommodated in the water tank through the water passage pipe 110 may be provided in the water tank 116. The water may be supplied from the water tank 116 to the water passage pipe 110 or be blocked through the water adjusting lever (not illustrated). Furthermore, when the water is supplied from the water tank 116 to the water passage pipe 110, an amount or a flow rate of the water supplied may be adjusted through the water adjusting lever (not illustrated). Here, although it has been described that the water is supplied to the water passage pipe 110 through the water tank 116, the inventive concept is not limited thereto, and the water may be supplied to the water passage pipe 110 through a hose by a water supply device (for example, faucet equipment or the like).

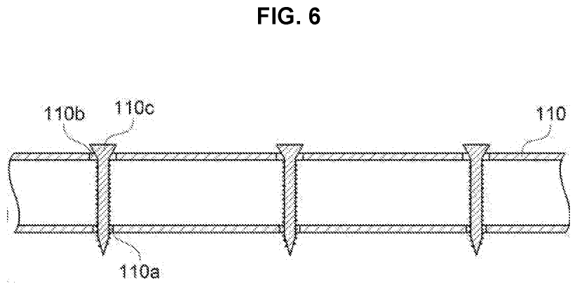

FIG. 6 is a view illustrating a water passage pipe according to an embodiment of the inventive concept. A plurality of water discharge holes 110a may be provided at a lower end of the water passage pipe 110 to be spaced apart from each other along a lengthwise direction of the water passage pipe 110. In this case, when the water is supplied from the water tank 116 to the water passage pipe 110, the water is discharged from the water discharge hole 110a while the water flows along the water passage pipe 110, and the discharged water is rinsed together with the foreign substances (or residues) that are present in the first grill part 108-1 while flowing down along the first grill part 108-1.

Here, when the water is discharged to the first grill part 108-1 through the water passage pipe 110 while the meat is grilled by the grill apparatus 100, foreign substances, such as impurities and oil, which drop to the first grill part 108-1 are rinsed while the water flows along the first grill part 108-1, and various unique fish smells of the meat are absorbed while moisture is evaporated by the first grill part 108-1 whereby the smells of the meat may be removed.

Furthermore, because the meat is grilled while the water flows on the surface of the first grill part 108-1, a moister texture may be felt as much gravy is not discharged from the meat, and because the foreign substances are rinsed down by the water in a process of grilling the meat, the meat may be grilled more safely from harmful substances generated while the meat is grilled and the grill part 108 may be managed more clearly.

A plurality of screw-coupling holes 110b may be provided at an upper end of the water passage pipe 110 to be spaced apart from each other along the lengthwise direction of the water passage pipe 110. A screw 110c may be coupled to each of the screw-coupling holes 110b. A diameter of the screw-coupling hole 110b may be larger than a diameter of the water discharge hole 110a.

In the water passage pipe 110, the screw-coupling hole 110b may be provided at a location corresponding to a location of the water discharge hole 110a. In an embodiment, the screw 110c may be provided to pass through the water discharge hole 110a. That is, a lower end of the screw 110c may pass through the water discharge hole 110a to protrude from the lower end of the water passage pipe 110. However, the inventive concept is not limited thereto, and a lower end of the screw 110c may be provided at a height corresponding to the water discharge hole 110a.

When the screw 110c is coupled to the screw-coupling hole 110b, the water flowing in an interior of the water passage pipe 110 is discharged through the water discharge hole 110a while flowing along a screw-thread formed on a surface of the screw 110c at a coupling location of the screw 110c whereby the water may be discharged from the water discharge hole 110a more easily. Then, because the screw 110c is coupled to the screw-coupling hole 110b, the water flowing along the water passage pipe 110 is discharged only through the water discharge hole 110a.

The cover part 112 may be configured to cover the grill receiving part 106 on an upper side of the grill receiving part 106. The cover part 112 may be coupled to a lateral side of the grill receiving part 106 to be rotatable. A window 112a may be provided in the cover part 112 such that the user may observe an interior thereof. Furthermore, an outtake 112b for discharging smoke generated when the meat is grilled to an outside may be provided in the cover part 112.

According to an embodiment, when the water is discharged to the grill part through the water passage pipe while the meat is grilled through the grill apparatus, foreign substances, such as impurities and oil, which drop to the grill part while the water flows along the grill part are rinsed down, and various unique fish smells of the meat are absorbed while moisture is evaporated from the grill part whereby the smells of the meat may be removed.

Furthermore, because the meat is grilled while the water flows on a surface of the grill part, a large number of gravy may be prevented from the meat and thus a moister texture may be felt, and because the foreign substances are rinsed down by the water in a process of grilling the meat, the harmful substances generated while the meat is grilled are rinsed down and thus the meat may be grilled to be eaten more safely from the harmful substances generated while the meat is grilled whereby the grill part may be managed clearer.

The technical effects that may be obtained by the inventive concept are not limited to the aforementioned problems, and any other effects not mentioned herein will be clearly understood from the following description by those skilled in the art to which the inventive concept pertains.

The above detailed description exemplifies the inventive concept. Furthermore, the above-described contents are for describing the preferred embodiments of the inventive concept, and the inventive concept may be used in various other combinations, changes, and environments. That is, the inventive concept may be modified or corrected in a range of the concept of the inventive concept disclosed in the specification, an equivalent range to the disclosed contents, and/or a technology or knowledge range of an ordinary person in the art. The embodiments are for describing the best state for implementing the technical spirit of the inventive concept, and various modifications required in the detailed application fields of the inventive concept and for the purposes of the inventive concept may be made. Accordingly, the detailed description of the inventive concept is not intended to limit the inventive concept by the disclosed embodiments. Furthermore, it should be construed that the attached claims include other embodiments.

What is claimed is:

1. A grill apparatus comprising:
a grill receiving part, an upper side of which is opened;
a grill part accommodated in an interior of the grill receiving part and in which a food is grilled; and
a water passage pipe provided in a widthwise direction of the grill receiving part on one side of the grill receiving part, provided on an upper side of the grill part, and configured to discharge water that flows in an interior thereof toward the grill part,
wherein the water discharged from the water passage pipe flows down along the grill part to remove foreign substances that are present on a surface of the grill part.

2. The grill apparatus of claim 1, wherein the grill receiving part includes:
a mounting recess provided on upper ends of opposite side plates on one side of the grill receiving part, and
wherein the water passage pipe is inserted into and mounted in the mounting recess.

3. The grill apparatus of claim 1, wherein the water passage pipe includes:
a plurality of water discharge holes provided at a lower end of the water passage pipe to be spaced apart from each other along a lengthwise direction of the water passage pipe, and
wherein the water supplied from an outside flows along an interior of the water passage pipe and is discharged to a lower side through the water discharge holes.

4. The grill apparatus of claim 3, wherein the water passage pipe further includes:
a plurality of screw-coupling holes provided at a lower end of the water passage pipe, spaced apart from each other along the lengthwise direction of the water passage pipe, to which screws are coupled respectively.

5. The grill apparatus of claim 4, wherein the screw-coupling holes are provided at locations corresponding to the water discharge holes.

6. The grill apparatus of claim 3, wherein the grill part is provided to be inclined downwards from one side to an opposite side of the grill receiving part and is configured such that the water discharged through the water discharge holes flows down to the opposite side of the grill receiving part along a surface of the grill part.

7. The grill apparatus of claim 6, further comprising:
a discharge hole provided on an opposite side of the grill receiving part and through which the water that flows down along the surface of the grill part is discharged.

8. The grill apparatus of claim 6, wherein the grill part includes:
a plurality of first grill parts arranged in parallel along the widthwise direction of the grill receiving part; and
a plurality of second grill parts provided on a lower side of the first grill parts, and arranged along the widthwise direction of the grill receiving part.

9. The grill apparatus of claim 8, wherein each of the first grill parts includes:
a concave inclined-part, opposite sides of which are inclined downwards toward a center thereof; and
an extension part extending upwards from one end of the concave inclined-part.

10. The grill apparatus of claim 9, wherein the extension part includes:
a first extension part extending from one end of the concave inclined-part at the same inclination angle as that of the concave inclined-part; and
a second extension part extending from an end of the first extension part at an inclination angle that is different from that of the first extension part.

11. The grill apparatus of claim 8, wherein the second grill part is provided in a form corresponding to the concave inclined-part, and is provided at a location corresponding to the concave inclined-part.

12. The grill apparatus of claim 8, further comprising:
a red clay layer formed on a surface of the second grill part.

13. The grill apparatus of claim 1, further comprising:
a grill support part, in which the grill receiving part is seated at an upper end thereof; and
a heat transfer part provided on a lower side of the grill receiving part on an inside of the grill support part and configured to transfer heat generated by a heat source to the grill receiving part.
